(19) United States
(12) Patent Application Publication
(10) Pub. No.: US 2024/0010394 A1
(43) Pub. Date: Jan. 11, 2024

(54) COSMETIC PRODUCT PACKAGING DEVICE

(71) Applicant: PARFUMS CHRISTIAN DIOR, PARIS (FR)

(72) Inventor: Damien VASSEUR, Paris (FR)

(21) Appl. No.: 18/267,852

(22) PCT Filed: Dec. 17, 2021
(86) PCT No.: PCT/FR2021/052394

§ 371 Date: Jun. 16, 2023

(30) Foreign Application Priority Data
Dec. 18, 2020 (FR) 2013751

(51) Int. Cl. B65D 41/16; A45D 40/00; A45D 34/04; B65D 43/02

(52) U.S. Cl. CPC B65D 41/16; A45D 40/00; A45D 34/045; B65D 43/0212; A45D 2040/0025; B65D 2543/00277; B65D 2543/0062; B65D 2543/00685; B65D 2543/00731

(57) ABSTRACT

A packaging device for at least one cosmetic product, comprises a case defining a housing. The case has a first snap-fit relief and a cover adapted to be fixed on the case to close the housing. The cover has a second snap-fit relief, adapted to cooperate with the first snap-fit relief to fix the cover on the case. One of the first snap-fit relief and the second snap-fit relief is made of metal and comprises at least one snap-fit tab extending between at least two slits.

### TECHNICAL FIELD

The present disclosure relates to the field of cosmetic product packaging devices.

### STATE OF THE ART

In the field of cosmetics, a packaging device generally comprises a case and a cover to dose this case. The cover may have an external metal casing. Such a metal casing is particularly popular among users.

However, the cover usually has a plastic insert. The insert may include magnets to cooperate with other magnets fixed to the case, to dose the packaging device.

Such an embodiment of the packaging devices, in particular of the cover of the packaging devices, however, has an ecological drawback. Indeed, in order to recycle the cover, it is necessary to take apart the insert, made in plastic, from the rest of the cover, made in metal. As a result, many covers are not recycled at all.

Furthermore, all-metal covers are known. However, these are generally screwed or force-fitted onto the case which they close.

Such means for closing the case by the cover are considered by users to be impractical. Users indeed prefer snap-fit fixing, the characteristic “click” of which allows the user to make sure that the packaging device is properly closed.

### SUMMARY

The present disclosure improves the situation.

The present disclosure provides a packaging device for at least one cosmetic product, comprising:
a case defining a housing, the case having at least one first snap-fit relief; and
a cover adapted to be fixed on the case to dose the housing, wherein the cover has at least one second snap-fit relief, adapted to cooperate with the at least one first snap-fit relief to fix the cover on the case,
   wherein one of the at least one first snap-fit relief and the at least one second snap-fit relief is made of metal and comprises at least one dipping tab extending between at least two slits.

Thus, advantageously, it is possible to fabricate a cosmetic product packaging device implementing at least one snap-fit relief which is made of metal. This metal snap-fit relief can be formed by the cover, an insert of the cover, the case or a hoop fitted on the case. In any event, this allows to be able to recycle a greater part of the packaging device, compared to the case where the member bearing this snap-fit relief is made of another material, in particular of plastic.

According to preferred embodiments, the packaging device may include one or several of the following features, alone or in combination:
the cover comprises a hood defining an internal cavity, and an insert fixed in the internal cavity of the hood, wherein the insert forms the at least one second snap-fit relief;
the hood and the insert are made of metal, in particular of the same metal;
each of the hood, the insert and/or said one of the at least one first snap-fit relief and the at least one second snap-fit relief is made of an aluminum alloy, in particular made of ZAMAC;
the insert has a thickness of between 0.1 mm and 5 mm;
the case comprises a case body and a hoop fixed to the case body, the hoop forming the at least one first snap-fit relief;
each clipping tab comprises a boss extending between the two respective slits;
the cover extends mainly along an axis, wherein the two slits are parallel to the axis, wherein the boss extends in a direction perpendicular to the axis where applicable;
the other one of the at least one first snap-fit relief and the at least one second snap-fit relief includes one of a groove, a rib, and at least one lug, preferably a plurality of lugs;
the at least one first snap-fit relief is on an outer lateral face of the case and the at least one second snap-fit relief is on an inner lateral face of the cover;
the packaging device extends mainly in a longitudinal direction, the at least one first snap-fit relief is on a first front face of the case, perpendicular to the longitudinal direction, and the at least one second snap-fit relief is on a second front face of the cover, perpendicular to the longitudinal direction;
   the case has an edge extending around an outlet of the housing, the at least one first snap-fit relief being on the edge, the at least one second snap-fit relief being preferably on a bottom of the cover;
the case has a shoulder on its external face, the cover having the shape of a socket having a cylindrical cavity adapted to accommodate a part of the case extending from the shoulder, wherein the cylindrical cavity is sealed at a first longitudinal end of the cover and open at a second longitudinal end, opposite the first longitudinal end, the at least one first snap-fit relief being on a first annular surface of the shoulder, and the at least one second snap-fit relief being on a second annular surface, at the second end of the cover;
the cover and the case are shaped so that the cover can be screwed onto the case until the at least one first snap-fit relief is snap-fitted with the at least one second snap-fit relief;
the case is a bottle with an opening through which the housing opens out, the bottle preferably comprising a cosmetic product in liquid form;
the cover is integral with an application member for applying the cosmetic product, in particular a brush (in French “brosse”) or a makeup brush (in French “pinceau”);
the bottle is provided with a pump device;
the pump is fixed to the bottle by means of a hoop screwed onto the bottle, the bottle having a screw thread in the vicinity of the opening, the screw thread being disposed closer to the opening than the at least one first snap-fit relief;
the case is wider and/or longer than it is high;
the cover is pivotally fixed to the case by means of at least one hinge, wherein the at least one hinge is preferably disposed on an opposite side of the cover with respect to the at least one second snap-fit relief; and
the case is a lipstick body, accommodating a lipstick mechanism and, preferably, a lipstick stick fixed to the lipstick mechanism.

### BRIEF DESCRIPTION OF THE DRAWINGS

Other features, details and advantages will appear reading the detailed description hereinafter, and upon considering the enclosed drawings, on which:

FIG. 1 shows a detail of a first example of a cosmetic product packaging device.

FIG. 2 is an exploded view of the cap of the first example of a cosmetic product packaging device.

FIG. 3 represents a detail of the bottle implemented in the first example of a cosmetic product packaging device.

FIG. 4 is a view of the detail from FIG. 1, according to cross-section plane IV-IV.

FIG. 5 is a view in longitudinal cross-section of a second example of a packaging device for a cosmetic product.

FIG. 6 represents, on the left half thereof, a longitudinal sectional view of a detail of the bottle implemented in the second example of a cosmetic product packaging device, and, on the right half thereof, a detail of FIG. 5.

FIG. 7 illustrates a third example of a cosmetic product packaging device, in an open state.

FIG. 8 illustrates an exploded view of the lid of the first example of a cosmetic product packaging device.

FIG. 9 is a view in longitudinal cross-section of a fourth example of a cosmetic product packaging device.

FIG. 10 is a view in longitudinal cross-section of a fifth example of a cosmetic product packaging device.

FIG. 11 is a schematic view in longitudinal cross-section of a sixth example of a cosmetic product packaging device.

FIG. 12 is a schematic view in longitudinal cross-section of a seventh example of a cosmetic product packaging device.

FIG. 13 is a schematic view in longitudinal cross-section of an eighth example of a cosmetic product packaging device.

### DESCRIPTION OF EMBODIMENTS

In the rest of the description, elements that are identical or have identical functions bear the same reference sign. For conciseness purposes, in this description, identical elements over several examples are not described in detail, within the framework of the detailed description of each such example. On the contrary, the description hereinafter details above all the differences between the various examples.

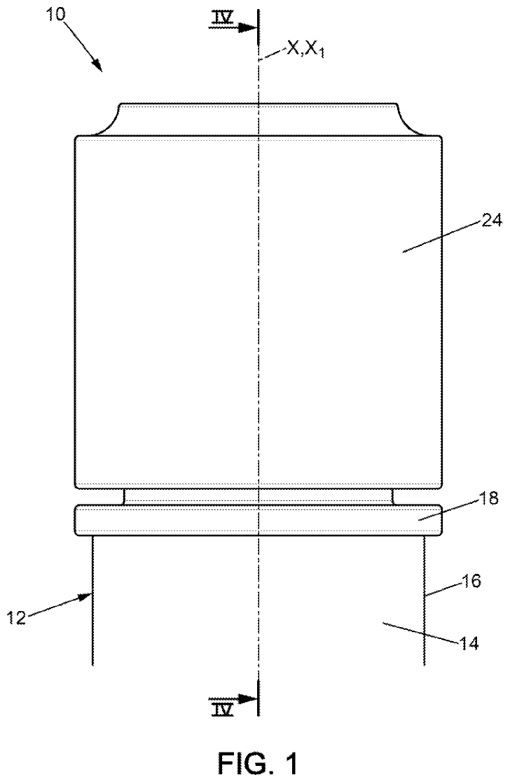

FIG. 1 illustrates a detail of a first packaging device 10 for a cosmetic product. The first packaging device 10 comprises a case 12, herein in the shape of a bottle 12. The bottle 12 contains a liquid cosmetic product, for example a perfume or an eau de toilette.

The bottle 12 extends mainly in one direction, in this case the direction of an axis X. In what follows, axis X is called “axis X of the bottle 12. The bottle 12 is for example rotationally symmetrical (in French “à symétrie par rotation”) about axis X of bottle 12, or even, as it is herein, circularly symmetrical (In French “à symétrie de révolution”) about axis X of bottle 12.

The bottle 12 here comprises a bottle body 14, forming a neck 16. At the end of the neck 16, the bottle 12 comprises a hoop 18, fixed on the bottle body 14, in this case on the neck 16 of the bottle body 14. Hoop 18 here extends neck 16 of bottle 12.

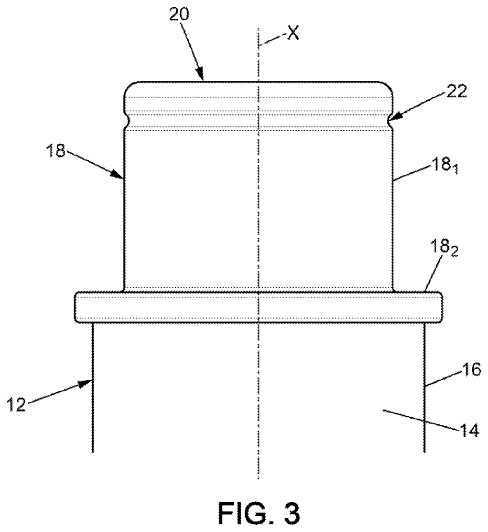

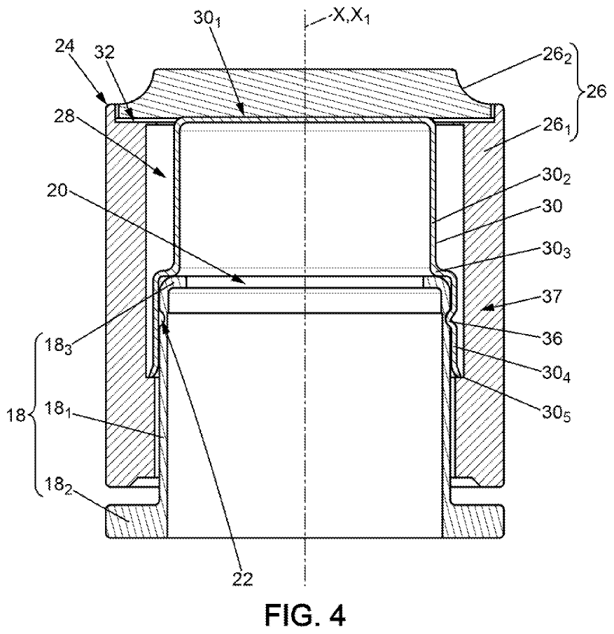

Hoop 18 is herein rotationally symmetrical about axis X of bottle 12. As is more particularly visible in FIGS. 3 and 4, hoop 18 comprises two adjacent portions 18₁, 18₂, each generally cylindrical in shape, and a substantially annular portion 18₃, in this case in the general shape of a washer. The two cylindrical portions 18₁, 18₂ are herein superimposed in the direction of axis X of the bottle 12. The annular portion 18₃ defines the free end of the hoop 18, remote from the bottle 12. The annular portion 18₃ of hoop 18 herein defines an opening 20 of the bottle 12, in fluid communication with the interior of the bottle body 14. The upper cylindrical portion 18₁ is adjacent to the annular portion 18₃, the upper cylindrical portion 18₁ and the annular portion 18₃ forming a shoulder. The lower cylindrical portion 18₂ of hoop 18, oriented towards bottle 12, is fixed to the neck 16 of the bottle body 14. Herein, the lower cylindrical portion 18₂ of hoop 18 has an outer diameter greater than the outer diameter of the upper cylindrical portion 18₁ of hoop 18, which is substantially equal to the outer diameter of the annular portion 18₃. According to the illustrated example, the lower cylindrical portion 18₂ of hoop 18 has an inner diameter equal to the inner diameter of the upper cylindrical portion 18₁ of hoop 18, but greater than the inner diameter of the annular section 18₂.

The upper cylindrical portion 18₁ of hoop 18 has, in the vicinity of the opening 20, a first snap-fit relief 22, herein in the form of a groove 22. Here, the groove 22 is circular. According to the illustrated example, the groove 22 is herein continuous all around the upper cylindrical portion 18₁. The groove 22 is here included in a plane perpendicular to axis X of the bottle 12.

The hoop 18, in particular the upper cylindrical portion 18₁ and, where applicable, the annular portion 18₃ may have a thickness greater than or equal to 0.3 mm and/or less than or equal to 5 mm. The hoop 18 is thus rigid, in particular sufficiently rigid so that it is difficult or even impossible to deform hoop 18 with bare hands.

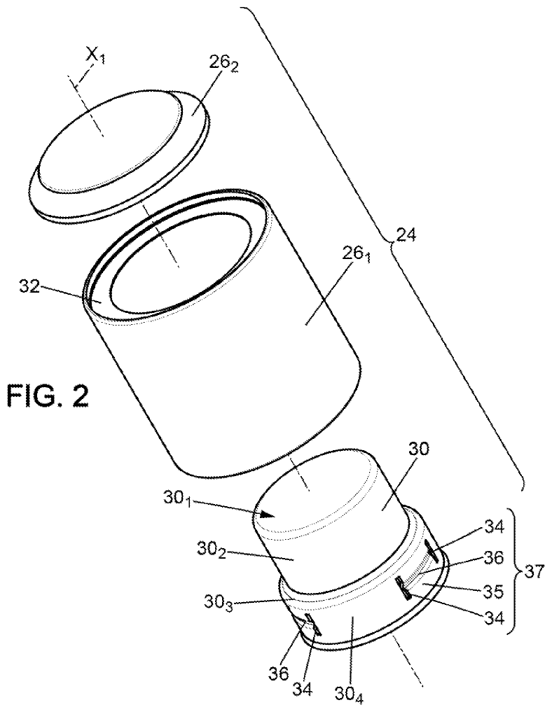

To close opening 20, and thus close the case 12, the packaging device 10 herein comprises a cover 24. Here, the cover takes the form of a cap 24. The cap 24 is more clearly visible in FIGS. 2 and 4.

As can be seen in the figures, the cap 24 has a circularly symmetrical shape around an axis X₁ of the cap 24, corresponding to axis X of bottle 12 when the cap 24 is fixed on the bottle 12.

As can be seen in these figures, the cap 24 herein comprises a hood 26 defining an internal cavity 28, and an insert 30, fixed in the internal cavity 28 of the hood 26. The hood 26 thus has the shape of a socket with a circular section, open at only one end.

The hood 26 comprises herein a first part 26₁, which is substantially cylindrical, having as an axis the axis X₁ of the cap 24, one end of which is plugged by a second part 26₂ of the hood 26. The second part 26₂ here has substantially the shape of a disc. Herein, the second part 26₂ bears and is fixed on an internal annular surface 32 of the first part of the hood 26₁. The second part 26₂ of the hood 26 can in particular be glued or welded to the first part 26₁ of the hood 26. Other fixing means for fixing the second part 26₂ of the hood 26 to the first part 26₁ of the hood 26 are also accessible to those skilled in the art.

The insert 30 also has the shape of a socket in the illustrated example, having as an axis the axis X₁ of the cap 24. A first longitudinal end 30₁ of the insert 30 is thus solid, while a second longitudinal end 30₅, opposite the first longitudinal end 30₁ of the insert 30, is open. In the vicinity of the first longitudinal end 30₁, insert 30 forms a first cylindrical portion 30₂ extending longitudinally in the direction of the axis X₁ of the cap 26, up to a shoulder 30₃. The insert 30 here comprises a second portion 30₄, substantially cylindrical, extending from shoulder 30₃, until the second longitudinal end 30₅ of insert 30. The cylindrical second portion 30₄ here comprises inner and outer diameters greater than the inner and outer diameters of the first cylindrical portion 30₂, respectively. The inner diameter of the second cylindrical portion 30₄ of insert 30 is here substantially equal to the outer diameter of the upper cylindrical portion 18₁ of hoop 18.

In the illustrated example, the second cylindrical portion 30₄ of insert 30 is slightly flared in the vicinity of the second longitudinal end 30₅ of insert 30.

The insert 30 has a thickness which may for example be greater than or equal to 0.1 mm and/or less than or equal to 5 mm, or even less than 1 mm. Thus, the insert 30 is also rigid, so that the insert is difficult to deform with bare hands, or it is even impossible to deform the insert 30 with bare hands.

Herein, on the second cylindrical portion 30₄, the insert 30 comprises a plurality of pairs of slits 34. Here, the pairs of slits 34 are regularly distributed angularly around axis X₁ of the cap 24, on the surface of the second cylindrical portion 30₄. The slits 34 are here all identical. By slit is meant herein an opening, herein radial in the insert 30. Thus, each slit 34 passes through the thickness of the body in which it is formed, herein the thickness of the insert 30. Each slit 34 can be fabricated by removing material from the body in which it is created, in this case from the insert 30. Alternatively, however, each slit 34 can be fabricated by cutting out the body in which it is created, herein in the insert 30, substantially without removing material from this body, respectively from the insert 30. In any event, each slit 34 separates two edges out of the same material of the body in which it is fabricated in a radial and/or orthoradial direction, herein two edges of insert 30. Each slit 34 extends herein longitudinally, parallel to axis X₁ of cap 24. As seen in FIG. 2 in particular, each slit 34 is non-opening, in that each slit 34 extends between two longitudinal ends formed in insert 30, more particularly in the second cylindrical portion 30₄ of insert 30 in the example shown in FIG. 2. Each slit 34 passes through the thickness of the insert 30, in particular that of the second cylindrical portion 30₄ of the insert 30. The insert 30 comprises for example at least two pairs of slits 34, preferably at least three pairs of slits 34, even more preferably at least four pairs of slits 34. The slits 34 make it possible to make the material of the insert 30 extending between the two slits 34 substantially more flexible.

Between two slits 34 of a pair of slits 34, the second cylindrical portion 30₄ of insert 30 forms a tab 35 for snap-fitting, comprising a boss 36 radially oriented towards the inside of insert 30. Each boss 36 is here fabricated by embossing.

As illustrated in FIG. 2, each tab 35 is integrally formed, at each end thereof, with the rest of insert 30, in particular with the rest of the second cylindrical portion 30₄ of insert 30. Each tab 36 is separated from the rest of the insert 30, along the lateral sides of the tab 36, extending parallel to axis X₁ of the cap, by the slits 34 which each extend along a lateral side of the tab 35.

Each tab 35 may extend, with the exception of the boss 36 where applicable, in the cylindrical extension of the rest of the insert 30 (i.e., of the insert 30 without the tabs 35) or more generally of the body in which the slits 34 delimiting the tabs 36 are formed. Alternatively, however, each tab 35 does not extend in the cylindrical extension of the rest of the insert 30.

Each tab 35—and therefore each slit 34—can have a length, herein measured along the direction of axis X₁ of the cap 24, greater than or equal to 2 mm, preferably greater than or equal to 4 mm, and/or less than or equal to 15 mm, preferably less than or equal to 10 mm.

Each boss 36 extends longitudinally in a direction perpendicular to the axis X₁ of the cap 24, herein in an orthoradial direction with respect to the axis X₁ of the cap 24. Each boss 36 can stretch over the entire width of the corresponding tab 36. Alternatively, however, each boss 36 is over only part of the width of tab 35. In particular, each boss 36 can be over at least half the width of the tab 35, preferably over at least three-quarters of the width of the tab 36.

Each boss 36 can be formed substantially in the middle of the height of the corresponding tab 35. The tab 35 deformation is indeed substantially greater in the middle of its height than at its longitudinal ends, in particular.

The boss 36 has a height, measured along the direction of axis X₁ of cap 24, which is less than the height of the slits 34, measured along the same direction of axis X₁ of cap 24. For example, the height of the boss 36 is greater than or equal to 0.1 mm, preferably greater than or equal to 0.5 mm, and/or less than or equal to 3 mm, preferably less than or equal to 2 mm. The width of the boss 36, measured in a circumferential or orthoradial direction, may be greater than or equal to 1 mm, preferably greater than or equal to 2 mm, and/or less than or equal to 20 mm, preferably less than or equal to 10 mm. The distance between the top of the boss 36 and the cylindrical envelope of insert 34, measured in a radial direction with respect to axis X₁ of cap 24, can be less than 2 mm, preferably less than 1 mm. The tab 35 thus has good flexibility, while retaining satisfactory mechanical resistance.

Each tab 35 provided with a boss 36 extending between two slits 34 thus forms a second snap-fit relief 37 on insert 30. Preferably, each second snap-fit relief 37 consists of such a tab 36 extending between two slits 34 and provided with a boss 36. Also remarkably, such a second snap-fit relief 37 is formed by a metal part, in this instance by the insert 30 made of metal. In other words, it is thereby possible to fabricate a second snap-fit relief 37 having sufficient elasticity to deform in order to allow fixing the cap 24 onto bottle 12 by snap-fitting, even if this second snap-fit relief 37 is formed by a metal part, in this case the insert 30 which here is made of metal.

As visible in FIG. 4, in particular, the insert 30 is sandwiched longitudinally, between the first part 26₁ of hood 26 and the second part 26₂ of hood 26, in the vicinity of the first end 30₁ of the insert 30. In particular, the second cylindrical portion 30₄ of the insert 30 abuts, at the level of the second longitudinal end 30₅, against an annular surface 38 formed by a shoulder inside the first part 26₁ of hood 26. The first longitudinal end 30₁ of the insert 30 can also be in abutment against and/or fixed on the second part 26₂ of the hood 26.

Each of hoop 18, hood 26 and insert 30 may be made of metal, in particular an aluminum alloy, more particularly ZAMAC, an alloy of zinc, aluminum, magnesium and copper in which zinc is included in a large majority. Advantageously the hood 26 and the insert 30 are made of the same material. Alternatively, or additionally, the hoop 18 and the insert 30 are made of the same material. It appears particularly advantageous that the hoop 18, the hood 26 and the insert 30 are all made of the same material.

To close bottle 12, the cap 24 is pushed along the direction of the axis X of the bottle 12, towards the bottle 12. The tabs 35 between two adjacent slits 34, carrying the bosses 36, are then elastically deformed by contact with the hoop 18, in particular with the upper cylindrical portion 18₁ of the hoop 18. Specifically, each boss 36 is flattened radially and/or locally pushes back tabs 35 between two adjacent slits 34. When the bosses 36 arrive opposite the groove 22, each boss 36 and/or each tab 36 expands elastically. Each boss 36 is then received into groove 22. Accommodating the bosses 36 in the groove 22 can come with a “click” distinctive of snap-fitting (or “clipping”) fixing cap 24 onto hoop 18 of the bottle 12. This fixing type is particularly popular among users because it makes it possible to ensure that the cap 24 is properly fixed to the bottle 12. This snap-fitting thereby implements the snap-fit tabs 35 provided with a boss 36, which extend between two neighboring slits 34.

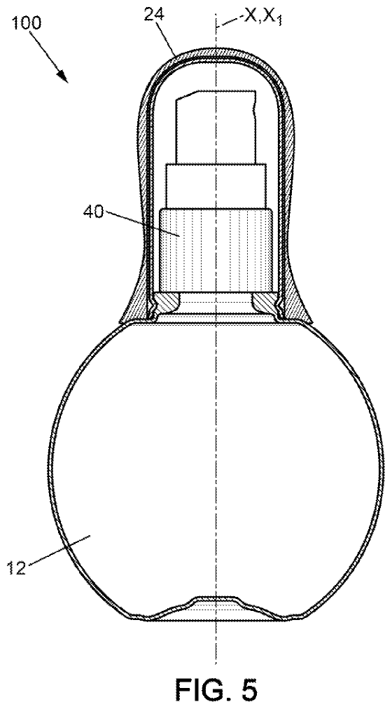

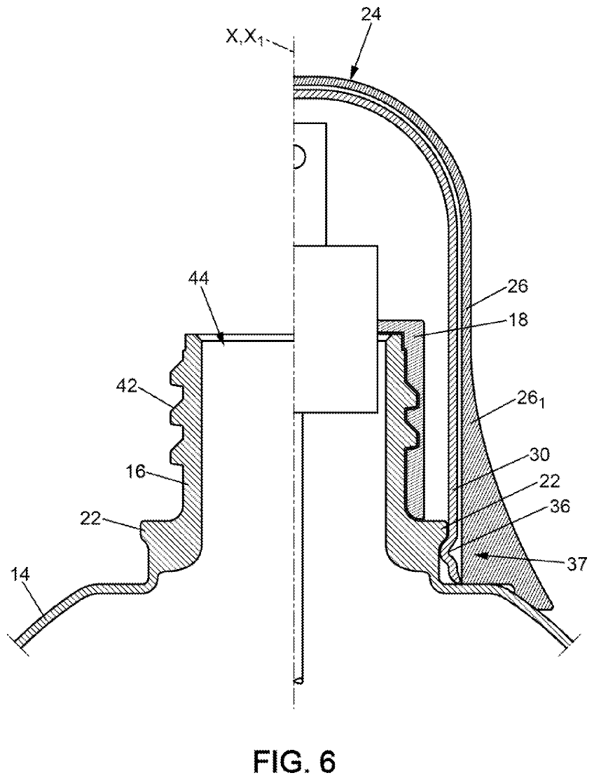

FIGS. 5 and 6 illustrate a second example of a cosmetic product packaging device 100.

According to this second example, the bottle 12 is provided with a pump 40. To this end, herein, the neck 16 of the bottle body 14 has a thread 42 extending in the vicinity of the opening 44 of the neck 16 of the bottle body 14. Herein, the hoop 18 makes it possible to fix the body of the pump 40 on the neck 16 of the bottle body 14.

The first snap-fit relief 22 takes herein the form of a circular rib extending all around the neck 16. The first snap-fit relief 22 is disposed such that the thread 42 extends between the first snap-fit relief 22 and the opening 44 of the neck 16, this in order to allow the pump 40 to be fixed on the neck 16, and, above the pump 40, the cap 24 on the bottle 12.

As illustrated in the right half of FIG. 6, herein, the cap 24 is snap-fitted on the bottle 12, in particular on the neck 16 of bottle 12, by cooperation of the first snap-fit relief 22 on bottle 12, with second snap-fit reliefs 37 on the insert 30, as described in the first example.

It should be noted here that bottle 12 can be made of any material accessible to those skilled in the art. The bottle 12 may in particular not be made of metal, so that fixing the cap 24 on the bottle 12 is then achieved by snap-fit reliefs of which only one is made of metal, herein the second snap-fit relief 37.

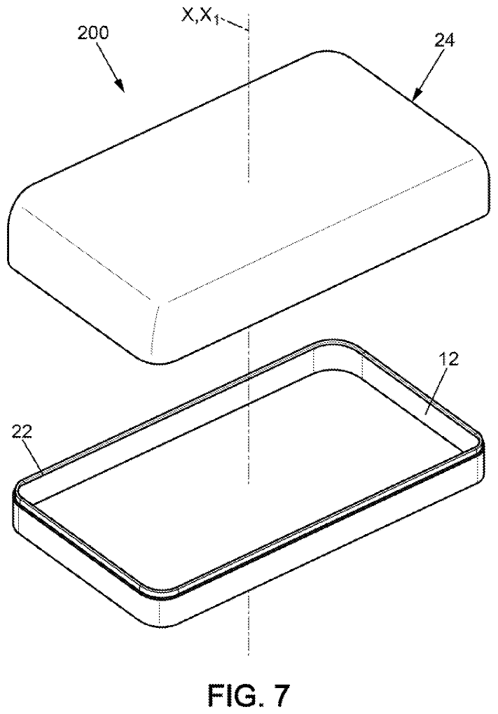

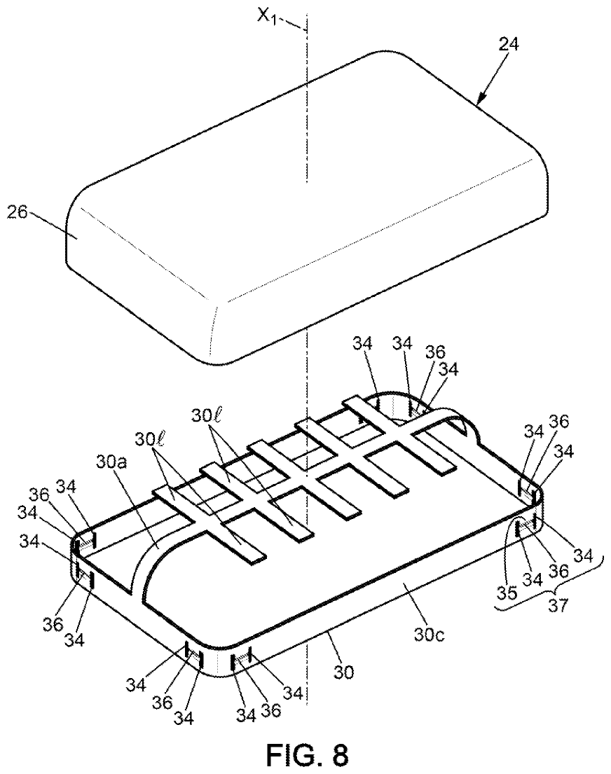

FIGS. 7 and 8 illustrate a third example of a cosmetic product packaging device 200. This third example of a packaging device 200 is a priori more particularly suited to packaging cosmetic products in solid form, in particular in powdery, pasty or gel form.

This third cosmetic product packaging device 200 example thus comprises a case 12 which is wider and longer than it is high. The case 12 can in particular define compartments, each compartment being filled with a different cosmetic product.

In this case, the cover 24 takes the form of a lid.

Here, the insert 30, made of metal, essentially has the shape of a crown 30c, on which tabs 35, slits 34 and bosses 36 of the second snap-fit reliefs 37, as previously described with regard to the first two examples, are provided. The second snap-fit reliefs 37 are for example on each side of crown 30c of insert 30, in the vicinity of each corner of crown 30c. Two opposite sides of crown 30c are herein joined by an arch 30a formed by insert 30. The arch 30a also forms reinforcing tabs 30l. These reinforcing tabs 30l can in particular consolidate fixing the insert 30 in the internal cavity 28 delimited by lid 24, for example when the reinforcing tabs 30l are glued to the lid 24.

To cooperate with the bosses 36 of the second snap-fit reliefs 37 of insert 30 and allow snap-fit of lid 24 on the case 12, the edge of the case 12 here forms a first snap-fit relief 22, protruding. For example, the edge of the case 12 is bent so as to form a rib 22 extending over the entire perimeter of the case 12.

Alternatively, lid 24 can be rotatably mounted relative to case 12, on one side of case 12, through at least one hinge. In this case, the insert 30 of lid 24 may have fewer second snap-fit reliefs 37 in the form of sets of tabs 36 extending between two neighboring slits 34 and each provided with a boss 36 extending between the two neighboring slits 34. For example, insert 30 may comprise a single such second snap-fit relief 37, on one side of the lid 12, opposite the side of the hinge.

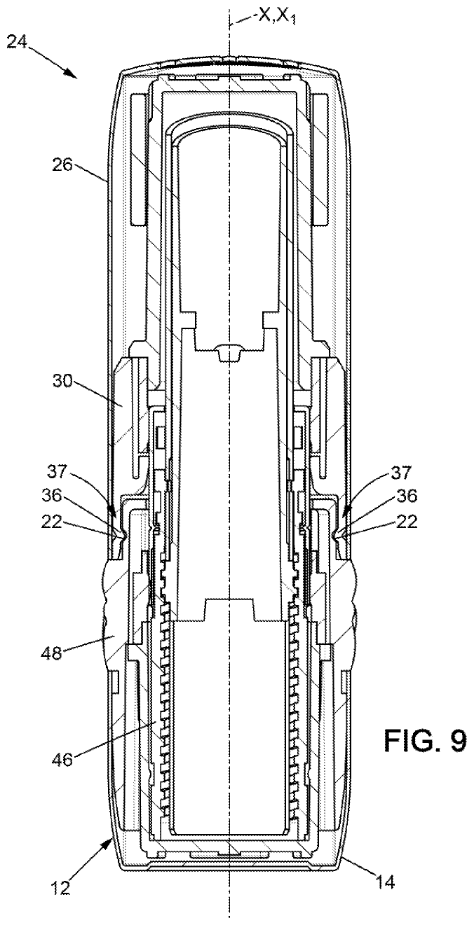

FIG. 9 illustrates a fourth example of a cosmetic product packaging device 300. This one is more specifically a packaging device for a lipstick or a lip care product.

In this case, the case 12 accommodates a lipstick mechanism 46, accommodating a lipstick bar (not represented). In a known manner, such a lipstick mechanism 46 makes it possible to move the lipstick bar along longitudinal direction X of the packaging device 300, by rotating a ring 48 of the case 12.

Here again, the cap 24 of the packaging device 300 and the lipstick body 14 may be similar to what has been described with regard to FIGS. 1 to 4, so that the cap 24 is fixed to the lipstick body 14 by snap-fit of first and second snap-fit reliefs 22, 37 as previously described.

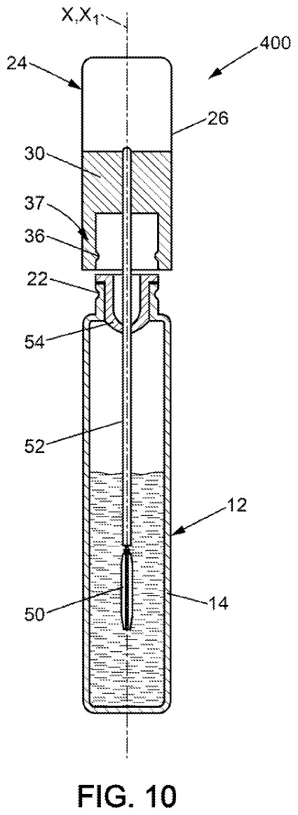

FIG. 10 illustrates a fifth example of a packaging device 400 in which the cap 24 is integral with an applicator member 50 for the cosmetic product, for example a brush or a makeup brush. The cosmetic product is then more particularly adapted for being applied to eyelashes, eyebrows or lips. The cosmetic product can in particular be a mascara or a gloss.

Here, the applicator member 50 is integral with a stem 52, itself integral with insert 30. Stem 52 is long enough to allow applicator member 50 to be immersed in the cosmetic product, when the cap 24 is attached to bottle 12. In this closed position of the packaging device 400, the stem 42 passes through a wiping device 54 making it possible to eliminate the superfluous cosmetic product taken up by the applicator member 50, when the latter is withdrawn from bottle 12.

In this fifth example of packaging device 400, also, the cap 24 can be fixed on the bottle 12 by snap-fit of first and second snap-fit reliefs 22, 37 as described above.

The present disclosure is not limited to the examples described above, solely by way of illustration, but it encompasses all the variants that those skilled in the art may consider within the framework of the sought protection. In particular, the different examples described above can be combined as long as their teachings are not contradictory.

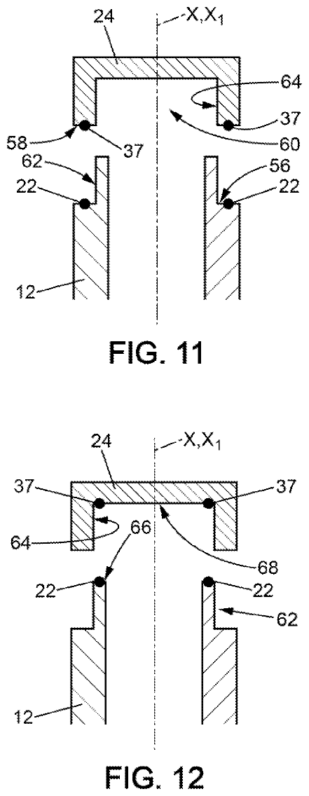

In addition, the positions of the first and second snap-fit reliefs 22, 37 allow for numerous variants accessible to those skilled in the art. FIGS. 11 to 13 illustrate examples thereof.

Thus, in FIG. 11, the first snap-fit reliefs 22 are on a first front face 56 of the case 12, perpendicular to longitudinal direction X. The first front face 56 is herein formed by an annular surface of a shoulder formed on the external face of case 12, in particular of the neck 16 of case 12. The second snap-fit reliefs 37 are on a second front face 58 of the cover 24, perpendicular to the longitudinal direction X. Herein, the second front face 568 corresponds to the annular ledge of a cavity 60 in cover 24. In this case, it is interesting that the external cylindrical surface 62 of case 12 and the internal cylindrical surface 64 of cover 24 each have a complementary thread to the other. Thus, cover 24 is fixed onto case 12 by screwing it until snap-fitting of the first and second snap-fit reliefs 22, 37.

In the case of the example of FIG. 11, each dipping tab 35 and the slits 34 delimiting it can then extend substantially in a plane normal to axis X₁ of cover 24. In particular, each clipping tab 35 and the slits 34 delimiting it extend longitudinally in a radial or orthoradial direction with respect to axis X₁ of cover 24. To this end, the slits 34 and the corresponding clipping tabs 35 can be formed on an annular portion of an insert fixed inside a hood delimiting the cavity 60, the annular portion forming the second front face 58 of cover 24. Each boss can then also extend in a plane normal to axis X₁. In particular, each boss extends longitudinally in a direction perpendicular to the direction of the slits delimiting the clipping tab on which the pertaining boss is formed. The distance between the top of the boss 36 and the base annular surface, in which the slits delimiting the dipping tabs are fabricated, measured in the direction of axis X₁ of cap 24, may be less than 2 mm, preferably less than 1 mm.

Alternatively, clipping tabs may be formed on first front surface 66 of case 12. In particular, the clipping tabs can be formed by a hoop fixed to case 12, comprising an annular surface forming the first front surface 66. The orientations of the tabs, slits and bosses may be identical to those indicated previously, taking as reference axis X of case 12 instead of axis X₁ of cover 24.

According to the example of FIG. 12, the first snap-fit reliefs 22 are formed on an annular edge 66 forming the longitudinal end of the case 12, the annular edge 66 being perpendicular to the direction of axis X of case 12. The annular edge 66 extends around an outlet of the housing in the case 12. The annular edge 66 is sometimes called the rim (in French “buvant”), especially when the case 12 is a bottle.

In the case of FIG. 12, the second snap-fit reliefs 37 can then be on the bottom 68 of the cover 24 in the form of a socket.

In the case of FIG. 12 also, the cover 24 can be screwed onto the case 12 until the first and second snap-fit reliefs 22, 37 snap-fit.

In the case of the example of FIG. 12, clipping tabs can be fabricated substantially as just described for the example of FIG. 11, in particular on an insert fixed inside cover 24 or on a hoop fixed to case 12. In particular, the orientation of the clipping tabs, of the slits delimiting these dipping tabs and of the bosses on these dipping tabs may be identical to those indicated in the description of the example of FIG. 11.

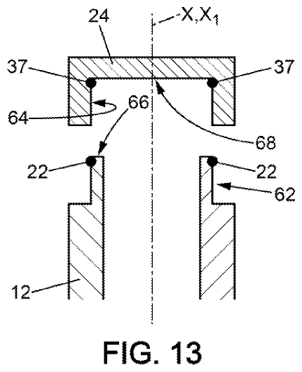

According to the example of FIG. 13, the first and second snap-fit reliefs 22, 37 are on the cylindrical surfaces 62, 64, respectively in the vicinity of the rim 66 and the bottom 68. In this case, the cover 24 can be fixed by snap-fitting of the first and second snap-fit reliefs 22, 37 by moving the cover 24 relative to case 12 in the direction of axis X of the packaging device. Alternatively, the cover 24 can be screwed onto the cover 12 until the first and second snap-fit reliefs 22, 37 snap-fit.

Here, the second snap-fit reliefs can be fabricated as described with regard to FIG. 2, in particular. In particular, the orientations of the clipping tabs, slits and bosses may be identical to those indicated in the description of this example embodiment. For example, the position of the second snap-fit reliefs could be moved along axis X₁ of cover 24, on the insert 30, with respect to the position illustrated in FIG. 2.

Alternatively, the clipping tabs could form the first dipping reliefs 22. In this case, the dipping tabs, the slits and the corresponding bosses can be fabricated in the vicinity of an outlet of case 12, in particular on a cylindrical surface whose axis corresponds to axis X of the case 12. The orientations of the dipping tabs, of the slits and of the corresponding bosses can then be identical to those described with regard to the example of FIG. 2, taking as a reference axis the axis X of case 12, instead of axis X₁ of cover 24.

Also, as mentioned above and unlike in the illustrated examples, in which each time the second snap-fit reliefs 37 carried by cover 24 take the form of a metal tab 35 delimited by two slits 34 and bearing a boss 36, alternatively, the first snap-fit reliefs 22 can take such a form. In this case, it is advantageous for the first snap-fit reliefs 22 to be formed by a metal case, in particular by a metal case body, or by a metal hoop fixed to such a case body, in particular if the case body is not metallic. In fact, snap-fit reliefs are thus fabricated on metal parts on which it is normally very difficult to fabricate such snap-fit reliefs.

In addition, in the described examples, use is made of tabs 35 for snap-fitting comprising bosses 36, in particular formed by embossing. However, other shapes of the tabs 35 for snap-fitting can be contemplated.

Finally, the relief(s) with which these snap-fit tabs cooperate can take different forms, in particular one of a groove, a rib and at least one lug, preferably a plurality of lugs.

1. A packaging device for at least one cosmetic product, comprising:
a case defining a housing, the case having at least one first snap-fit relief; and
a cover adapted to be fixed on the case to close the housing, wherein the cover has at least one second snap-fit relief, adapted to cooperate with the at least one first snap-fit relief to fix the cover on the case,
wherein one of the at least one first snap-fit relief and the at least one second snap-fit relief is made of metal and comprises at least one clipping tab extending between at least two slits.

2. The packaging device according to claim 1, wherein the cover comprises a hood defining an internal cavity, and an insert fixed in the internal cavity of the hood wherein, the insert forms the at least one second snap-fit relief.

3. The packaging device according to claim 2, wherein the hood and the insert are made of metal.

4. The packaging device according to claim 3, wherein each of the hood, the insert and/or said one of the at least one first snap-fit relief and the at least one second snap-fit relief is made of an aluminum alloy.

5. The packaging device according to claim 2, wherein the insert has a thickness of between 0.1 mm and 5 mm.

6. The packaging device according to claim 1, wherein the case comprises a case body and a hoop fixed to the case body, the hoop forming the at least one first snap-fit relief.

7. The packaging device according to claim 1, wherein each of the at least one clipping tab comprises a boss extending between the two respective slits.

8. The device according to claim 1, wherein the cover extends mainly along an axis, the two slits being parallel to the axis.

9. The packaging device according to claim 1, in which the other one of the at least one first snap-fit relief and the at least one second snap-fit relief includes one of a groove, a rib, and at least one lug.

10. The packaging device according to claim 1, in which the at least one first snap-fit relief is on an outer lateral face of the case and the at least one second snap-fit relief is on an inner lateral face of the cover.

11. The packaging device according to claim 1, in which the packaging device extends mainly in a longitudinal direction, and wherein the at least one first snap-fit relief is on a first front face of the case, perpendicular to the longitudinal direction, and the at least one second snap-fit relief is on a second front face of the cover, perpendicular to the longitudinal direction.

12. The packaging device according to claim 11, wherein the case has an edge extending around an outlet of the housing, the at least one first snap-fit relief being on the edge.

13. The packaging device according to claim 11, wherein the case has a shoulder on its external face, the cover having the shape of a socket having a cylindrical cavity adapted to accommodate a part of the case extending from the shoulder, wherein the cylindrical cavity is sealed at a first longitudinal end of the cover and open at a second longitudinal end, opposite the first longitudinal end, the at least one first snap-fit relief being on a first annular surface of the shoulder, and the at least one second snap-fit relief being on a second annular surface, at the second end of the cover.

14. The packaging device according to claim 1, in which the cover and the case are shaped so that the cover can be screwed onto the case until the at least one first snap-fit relief is snap-fitted with the at least one second snap-fit relief.

15. The packaging device according to claim 1, in which the case is a bottle with an opening through which the housing opens out.

16. The packaging device according to claim 15, wherein the cover is integral with an application member for applying the cosmetic product.

17. The packaging device according to claim 15, wherein the bottle is provided with a pump device.

18. The packaging device according to claim 17, wherein the pump is fixed to the bottle by means of a hoop screwed onto the bottle, the bottle having a screw thread in the vicinity of the opening, the screw thread being disposed closer to the opening than the at least one first snap-fit relief.

19. The packaging device according to claim 1, wherein the case is wider and/or longer than it is high.

20. The packaging device according to claim 1, wherein the cover is pivotally fixed to the case by means of at least one hinge, wherein the at least one hinge is preferably disposed on an opposite side of the cover with respect to the at least one second snap-fit relief.

21. The packaging device according to claim 1, wherein the case is a lipstick body, accommodating a lipstick mechanism.
